(19) United States
(12) Patent Application Publication
(10) Pub. No.: US 2018/0163679 A1
(43) Pub. Date: Jun. 14, 2018

(54) Fuel Supply Devices

(71) Applicant: AISAN KOGYO KABUSHIKI KAISHA, Obu-shi, Aichi-ken (JP)

(72) Inventors: Kensuke NIWA, Obu-shi, Aichi (JP); Koji YOSHIDA, Obu-shi, Aichi (JP); Kazunori HIBI, Obu-shi, Aichi (JP); Ryosuke HAYASHI, Obu-shi, Aichi (JP); Shinji SHIMOKAWA, Obu-shi, Aichi (JP)

(73) Assignee: AISAN KOGYO KABUSHIKI KAISHA, Obu-shi, Aichi-ken (JP)

(21) Appl. No.: 15/555,464

(22) PCT Filed: Feb. 12, 2016
(86) PCT No.: PCT/JP2016/054074

§ 371 Date: Nov. 7, 2017

(30) Foreign Application Priority Data
Mar. 4, 2015 (JP) 2015-042605

(51) Int. Cl. F02M 37/22; B01D 35/00; B01D 35/027; B01D 35/30; F02M 37/10

(52) U.S. Cl. CPC F02M 37/22; B01D 35/005; F02M 37/10; B01D 35/30; B01D 35/0273

(57) ABSTRACT

A fuel supply device includes a fuel filter interposed between an upper outer frame member and a lower outer frame member. The fuel filter includes an upper filter member, a lower filter member and an inner space-defining-member having a portion that is positioned between the upper filter member and the lower filter member. A peripheral edge of the upper filter member and a peripheral edge of the lower filter member are joined together. The inner space-defining-member includes an interposed portion that, together with the upper filter member and the lower filter member, is fixed between the upper outer frame member and the lower outer frame member.

### TECHNICAL FIELD

The present invention relates to a fuel supply device. More particularly, it relates to a fuel supply device for supplying fuel within a fuel tank to an internal combustion engine, wherein the fuel tank is mounted to a vehicle such as an automobile.

### BACKGROUND ART

A fuel supply device utilized for supplying fuel within a fuel tank to an internal combustion engine is widely known. A fuel supply device having a fuel pump and a structure where a filter member is disposed on an upstream side of the fuel pump is also widely known. Japanese Laid-Open Patent Publication No. 2012-251481 discloses a fuel filter having an inner space-defining-member disposed between an upper filter member and a lower filter member.

The fuel filter is covered with upper and lower frame members. The filter members are solely caught between the upper and lower frame members while the inner space-defining-member is placed in an interior region defined between the frame members. Therefore, the fuel filter may not be stably supported. For example, abrupt negative pressure or vibration may be applied to the fuel filter, or the filter members may be contracted. In this case, force that may separate the fuel filter from the frame members may be generated.

### DISCLOSURE OF THE INVENTION

### Problem to be Solved by the Invention

Therefore, there is a need for a fuel supply device having a structure where a fuel filter is hardly slipped off from frame members even when such force is applied to the fuel filter.

### Means for Solving the Problem

According to one aspect of the present invention, a fuel supply device has a fuel filter, and an upper outer frame member and a lower outer frame member, wherein the fuel filter is interposed between the frame members. The fuel filter includes an upper filter member, a lower filter member and an inner space-defining-member having a portion that is positioned between the upper filter member and the lower filter member. A peripheral edge of the upper filter member and a peripheral edge of the lower filter member are joined together. The inner space-defining-member includes an interposed portion that is caught between the upper outer frame member and the lower outer frame member together with the upper filter member and the lower filter member. Therefore, the filter member is stably supported by both the upper outer frame member and the lower outer frame member.

According to another aspect of the present invention, the interposed portion of the inner space-defining-member is planar. More specifically, the interposed portion is formed to be planar such that no through hole is formed. Consequently, the interposed portion can be caught with uniform force when the fuel filter is interposed.

According to another aspect of the present invention, a through hole may be formed in the inner space-defining-member in a position at a predetermined distance from the interposed portion toward a center of the inner space-defining-member. Therefore, the fuel can be retained between the inner space-defining-member and the upper outer frame member even in a case when the fuel liquid surface within the fuel tank is tilted, for example, when a vehicle turns. As a result, the fuel retaining performance of the fuel supply device is improved.

According to another aspect of the present invention, a projection may be formed on an upper surface of the inner space-defining-member. The projection may be positioned between the interposed portion and a through hole formed in the inner space-defining-member. Therefore, the performance for retaining the fuel at an upper side of the inner space-defining-member may be improved.

### BRIEF DESCRIPTION OF DRAWINGS

FIG. 1 is a cross-sectional view of a fuel tank and a fuel supply device disposed within the fuel tank;

FIG. 2 is an exploded cross-sectional view of the fuel supply device;

FIG. 3 is an enlarged view in an area III of FIG. 1;

FIG. 4 is a plan view of an inner space-defining-member;

FIG. 5 is a view showing a condition where fuel is relatively shifted with respect to the fuel tank when a turning force is applied to the vehicle;

FIG. 6 is a plan view of an inner space-defining-member according to another embodiment;

FIG. 7 is a plan view of an inner space-defining-member according to another embodiment;

FIG. 8 is a cross sectional view of a fuel tank and a fuel supply device disposed within the fuel tank according to another embodiment;

FIG. 9 is a plan view of the inner space-defining-member according to the embodiment illustrated in FIG. 8;

FIG. 10 is a plan view of an inner space-defining-member according to another embodiment; and

FIG. 11 is a plan view of an inner space-defining-member according to another embodiment.

### EMBODIMENTS FOR CARRYING OUT THE INVENTION

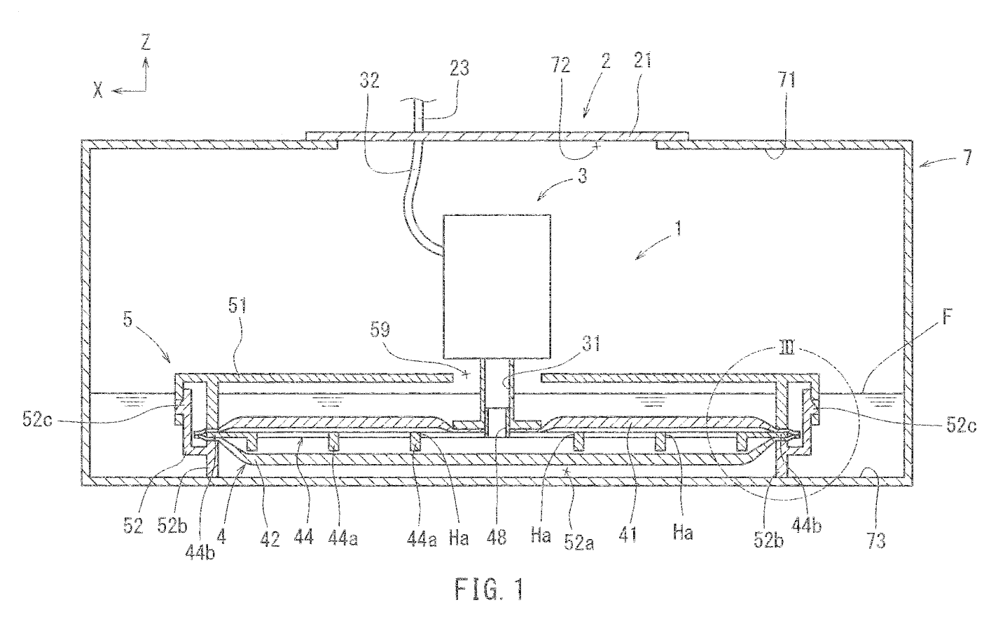

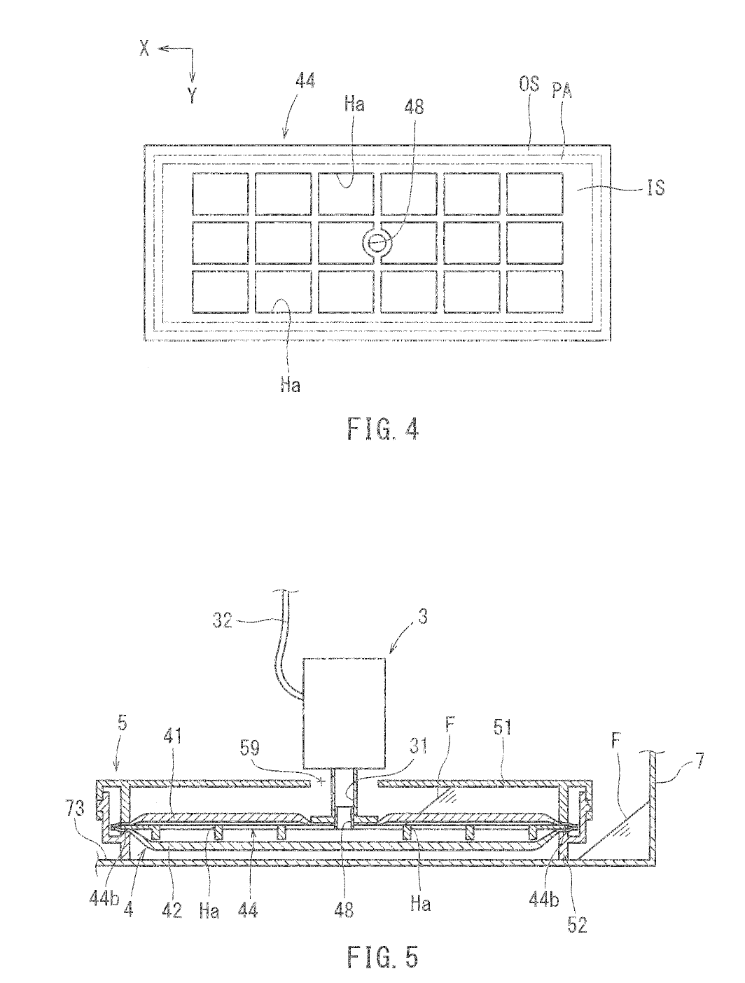

Hereinafter, an exemplary embodiment of the present invention will be described with reference to the drawings. A front-back direction is described in this specification, where X is defined as the front direction in FIG. 1 etc. A right-left direction is described, where Y is defined as the left direction in FIG. 4 etc. An upper-lower direction is described, where Z is defined as the upper direction. Typically, a pump unit 3 is positioned above a fuel filter 4 of a fuel supply device 1. The narrower sides of the substantially rectangular parallelepiped fuel filter 4 lie in a right-left direction when observed in a plan view. The longer sides lie in a front-rear direction orthogonal to the right-left direction. Hereinafter, the directions are referred to with an assumption that the fuel supply device 1 is attached to the tank 7 unless otherwise specifically noted.

A fuel supply device 1 according to the present exemplary embodiment is mounted to a vehicle, particularly an automobile. The fuel supply device 1 is attached to a fuel tank 7 arranged under a floor of a vehicle and delivers liquid fuel F stored in the fuel tank 7 to an internal combustion engine (not shown).

As shown in FIG. 1, a fuel supply device 1 has a cover member 2, a pump unit 3 and a fuel filter 4. The cover member 2 is attached to an opening 72 formed in an upper surface 71 of the fuel tank 7. The pump unit 3 includes an electric pump (not shown) that is utilized for delivering the fuel F stored within the fuel tank 7 to the outside. The fuel filter 4 serves to filter the fuel F to be sucked by the pump unit 3. The fuel filter 4 has an upper filter member 41 positioned at an upper side, a lower filter member 2 positioned at a lower side, and an inner space-defining-member 44 positioned in an interior space. The upper filter member 41, lower filter member 42 and inner space-defining-member 44 of the fuel filter 4 are positioned between an upper outer frame member 51 and a lower outer frame member 52.

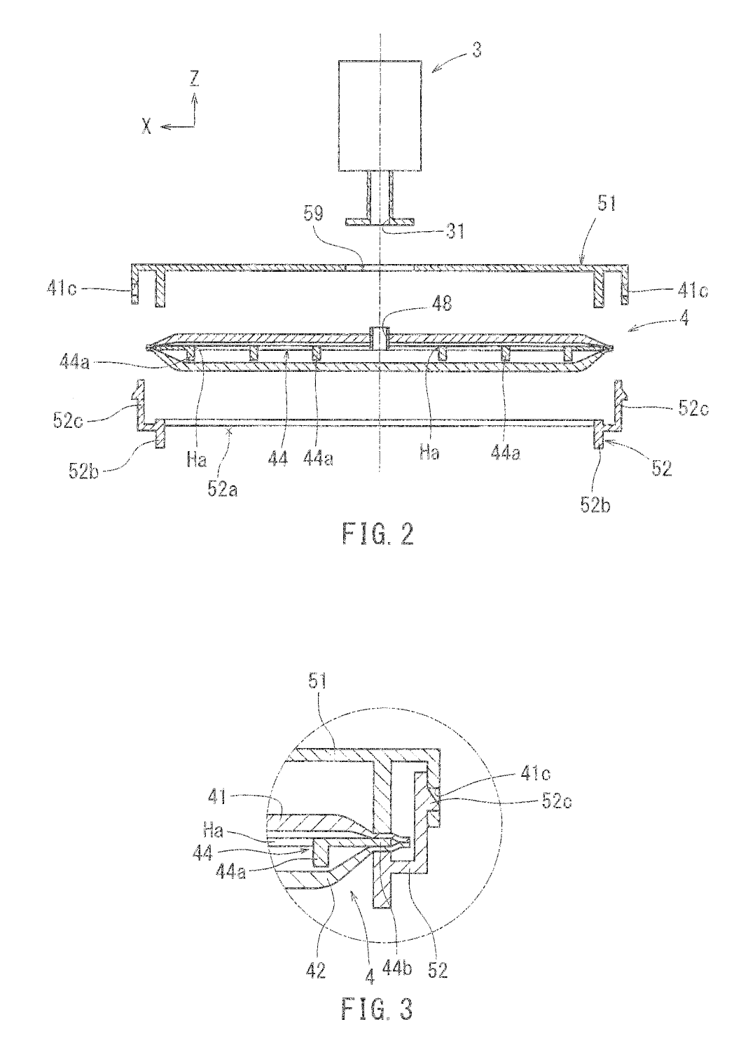

As shown in FIGS. 1 and 2, the lower outer frame member 52 is installed such that it may abut a bottom surface 73 of the fuel tank 7. More specifically, the lower outer frame member 52 is installed along the bottom surface 73 of the fuel tank 7 when the cover member 2 is arranged to cover the opening 72 of the fuel tank 7. A biasing mechanism (not shown) may be provided between the cover member 2 and the pump unit 3 or between the cover member 2 and the base 5. The biasing mechanism has a spring etc., which generates biasing force to press the lower outer frame member 52 against the bottom surface 73 of the fuel tank 7 when the cover member 2 is attached to the fuel tank 7.

As shown in FIG. 1, the cover member 2 has a set plate part 21 designed to cover the opening 72 of the fuel tank 7. The substantially disk-shaped set plate part 21 is provided with an outlet port 23 which is used for guiding the fuel F delivered from the pump unit 3 to the outside of the fuel tank 7. The set plate part 21 is provided with an electric connector (not shown) to which an electric wiring is connected. Since the opening 72 of the fuel tank 7 is normally circular, the set plate part 21 of the cover member 2 is also formed to have a substantially circular shape in a plan view.

As shown in FIG. 1, the pump unit 3 is arranged below the cover member 2. The pump unit 3 is connected to the fuel filter 4 such that the pump unit 3 sucks the fuel F through the fuel filter 4. The fuel filter 4 is connected to a base portion 5 which may abut the bottom surface 73 of the fuel tank 7. The base portion 5 is formed to be substantially planar and is arranged such that one side surface of the base portion 5 faces the bottom surface 73 of the fuel tank 7. The base portion 5 having the fuel filter 4 is also referred to as a fuel reservoir part or a sub-tank and is configured to be able to retain the fuel F temporally under predetermined conditions.

As shown in FIG. 1, the base portion 5 includes the upper outer frame member 51 facing opposite to an upper surface 71 of the fuel tank 7 and the lower outer frame member 52 which contacts the bottom surface 73 of the fuel tank 7. The fuel filter 4 is attached to the base portion 5 wherein the fuel filter 4 is interposed between the upper outer frame member 51 and the lower outer frame member 52. A suction opening 59 is formed at the upper outer frame member 51 to allow the fuel F to be introduced to the upper surface side of the fuel filter 4. The upper outer frame member 51 has a rectangular tubular side wall and an upper surface configured to close an upper part of the side wall, wherein a lower part of the side wall is opened. The suction opening 59 is provided near the center of the upper surface.

Referring to FIG. 1, the fuel F introduced from the suction opening 59 into a space (upper space) defined by the space between the fuel filter 4 and the upper outer frame member 51 forms an oil film on the fuel filter 4. The fuel F passes slightly hardly through the fuel filter 4 with the oil film formed. Due to the oil film, the fuel F positioned near the upper surface of the fuel filter 4 passes more slowly through and below the filter 4. A tubular lateral wall provided at the upper outer frame member 51 is configured to be impervious to the fuel F. Therefore, the movement of the fuel F in the upper space is more restricted than that the movement of the fuel F outside of the base portion 5.

As shown in FIGS. 1 and 2, the lower outer frame member 52 is formed with a bottom surface opening 52a that enables the fuel F positioned on the bottom surface 73 of the fuel tank 7 to contact the fuel filter 4. A plurality of downwardly extending legs 52b are formed on a lower surface of the lower outer frame member 52. Consequently, the fuel F can be sucked from the bottom surface opening 52a even when the lower outer frame member 52 is disposed to contact the bottom surface 73 of the fuel tank 7. The fuel F positioned on the bottom surface 73 of the fuel tank 7 can enter directly under the fuel filter 4 from a gap between the legs 52b. The lower filter member 42 is formed such that pressure loss is smaller when the liquid passes through as comparing with the upper filter member. Therefore, fuel passed mainly through the lower filter member 42 is drawn by the pump unit 3 when the sufficient fuel is accumulated in the fuel tank 7.

A pressure regulating valve (not shown) used for adjusting the feed pressure of the fuel F is attached to the pump unit 3. The fuel F with its pressure regulated by the pressure regulating valve is fed to the internal combustion engine through a hose 32 and an outlet port 23 etc.

As shown in FIGS. 1 and 3, the fuel filter 4 is configured by joining a peripheral edge of the upper filter member 41 and a peripheral edge of the lower filter member 42. The upper filter member 41 covers part of an upper side of the inner space-defining-member 44, and the lower filter member 42 covers a lower side of the inner space-defining-member 44. A presence of a member positioned between the upper filter member 41 and the lower filter member 42 of the fuel filter 4 may avoid the upper filter member 41 and the lower filter member 42 from being entirely tightly fitted to each other. As a result, a condition wherein a space is formed between the upper filter member 41 and the lower filter member 42 can be maintained.

The inner space-defining-member 44 is formed to have higher rigidity than that of the upper filter member 41 and/or the lower filter member 42, and serves to prevent deformation of the upper filter member 41 and/or the lower filter member 42. A part of the inner space-defining-member 44 is encased in a space defined by the upper filter member 41 and the lower filter member 42. Therefore, the peripheral edge of the upper filter member 41 and the peripheral edge of the lower filter member 42 are joined at an outer side than the outer edges of the inner space-defining-member 44. The upper filter member 41 and the lower filter member 42 are joined, for example, by welding.

As shown in FIG. 1, a suction port 48 formed approximately in the center of the fuel filter 4 is connected to a suction nozzle 31 of the pump unit 3. Thus, the pump unit 3 can suck the fuel F positioned under the suction port 48. The inner space-defining-member 44 has a plurality of projections 44a projecting downwardly from a plate-like part at intervals so that the plurality of projections 44a prevents the lower filter member 42 from contacting the inner space-defining-member 44 without space.

As shown in FIG. 2, the fuel filter 4 is interposed between the upper outer frame member 51 and the lower outer frame member 52. As shown in FIG. 3, the inner space-defining-member 44, as well as the upper filter member 41 and lower filter member 42, are caught between the upper outer frame member 51 and the lower outer frame member 52. The lower outer frame member 52 includes an elastically deformable claw 52c. The upper outer frame member 51 and the lower outer frame member 52 are coupled together wherein the claw 52c hooks into a hole 41c formed in the upper outer frame member 51.

As shown in FIG. 1, the inner space-defining-member 44 has an interposed portion 44b that is pressed by both the upper outer frame member 51 and the lower outer frame member 52. The interposed portion 44b is positioned along an outer periphery of the inner space-defining-member 44, wherein the peripheral location corresponds to a position in the region PA between two two-dot chain lines shown in FIG. 4. The inner space-defining-member 44 has an inner plane IS located inside of the region PA and an outer plane OS located outside of the region PA as seen in a plan view. The region PA is positioned along the entire outer periphery of the inner space-defining-member 44.

As shown in FIG. 4, a vertically passing through hole is not provided in the region PA (corresponds to the interposed portion 44b shown in FIG. 1), whereas the region PA (interposed portion 44b) disperses the force applied from the upper outer frame member 51 and lower outer frame member 52. The interposed portion 44b is, for example, a plate having a parallel surface facing the upper outer frame member 51 and a parallel surface facing the lower outer frame member 52. This may avoid the force applied from the upper outer frame member 51 and the lower outer frame member 52 from being locally concentrated.

As shown in FIG. 4, vertically extending through holes Ha are formed in the central area of the inner space-defining-member 44. The inner space-defining-member 44 includes, for example, three rows of through holes Ha in the right-left direction and six columns in the front-rear direction. This allows the fuel F to move in the up-down direction of the inner space-defining-member 44 through a plurality of through holes Ha. Because of this structure, after the fuel F positioned on the upper surface side of the upper filter member 41 has passed through the upper filter member 41, the fuel F moves to the area between the lower filter member 42 and the inner space-defining-member 44 through the through holes Ha formed in the inner space-defining-member 44, and can then be drawn into the pump unit 3.

As shown in FIG. 1, the fuel supply device 1 has an upper space defined by the upper filter member 41 and the upper outer frame member 51. The upper filter member 41 is configured such that the fuel F passes slightly hardly through, and the fuel F that has entered into the upper space will gradually shifted under the upper filter member 41. Therefore, the fuel F may easily be retained within the space defined by the upper filter member 41 and the upper outer frame member 51 as shown in FIG. 5, even when the force is applied to shift the fuel F to the side when, for example, the vehicle turns.

As shown in FIG. 1, the inner space-defining-member 44 is interposed between the upper outer frame member 51 and lower outer frame member 52 constituting the base portion 5. As a result, the inner space-defining-member 44 is inhibited from moving with respect to the base portion 5, while the fuel filter 4 is also inhibited from moving moved with respect to the base portion 5. In a plan view, the inner space-defining-member 44 is formed to be larger than the bottom surface opening 52a of the lower outer frame member 52. Therefore, the inner space-defining-member 44 is sized such that it cannot pass through the bottom surface opening 52a.

As shown in FIG. 1, the upper filter member 41 and the lower filter member 42, both made out of nonwoven fabric, are interposed between the upper outer frame member 51 and the lower outer frame member 52. Therefore, the upper filter member 41 is compressed between the inner space-defining-member 44 and the upper outer frame member 51. This prevents gap formation between the inner space-defining-member 44 and the upper outer frame member 51, and consequently prevents the fuel F from leaking through the gap.

As shown in FIG. 2, components may be successively piled on the lower outer frame member 52 that is fixed on such as a base so that the fuel filter 4 may be interposed between the upper outer frame member 51 and the lower outer frame member 52. The pump unit 3 is connected to the suction port 48 while applying the force from the upper side of the upper outer frame member 51 to the lower side. Alternatively, the pump unit 3 may be connected to the suction port 48 while the force is applied by utilizing the pump unit 3 from the upper side of the upper outer frame member 51 to the lower side. In this way, the fuel supply device 1 may be effectively assembled.

Embodiments are not limited to the above-described exemplary embodiment. The through holes formed in the inner space-defining-member 44 may be arranged at a predetermined distance away from the pressed region PA such that the fuel F can be easily retained in the space defined by the upper filter member 41 and the upper outer frame member 51. More specifically, a through hole may be provided only in a position apart from the region PA pressed by the upper outer frame member 51 and the lower outer frame member 52 toward the center of the inner space-defining-member 44 at a predetermined distance.

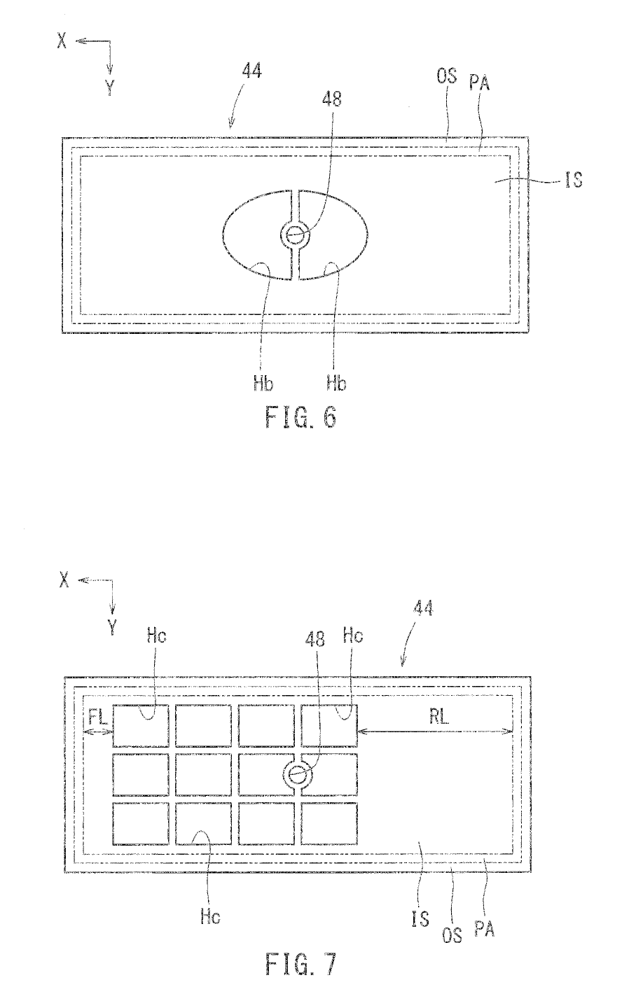

For example, as an exemplary embodiment shown in FIG. 6, through holes Hb may only be provided near the center of an inner plane IS of the inner space-defining-member 44. This configuration may define a pocket-like space for storing the fuel F near the region PA (interposed portion 44b). Therefore, the fuel F may be easily retained on the upper filter member 41 also when, for example, the vehicle is accelerated. As shown in FIG. 6, the through holes Hb are adjacent to the suction port 48 of the fuel filter 4. Consequently, the fuel F positioned on the upper surface side of the inner space-defining-member 44 is shifted under the inner space-defining-member 44 near the suction port 48. In this way, the fuel F can be easily sucked from the suction port 48.

the case of the exemplary embodiment shown in FIG. 6, referring to FIG. 1, the structure allows the fuel F to be easily retained on all four sides as viewed from the center of the space, which is defined by the upper filter member 41 and the upper outer frame member 51. Alternatively, it is also possible to adopt a structure in that the fuel F can be more easily retained in the space defined in (a) predetermined direction(s) as viewed from the center of the space rather than in space provided in other directions. For example, as an exemplary embodiment shown in FIG. 7, it is also possible to determine a distance RL from a rear part of the region PA (interposed portion 44b) to the through hole He longer than a distance FL from a front part of the region PA (interposed portion 44b) and the through hole He.

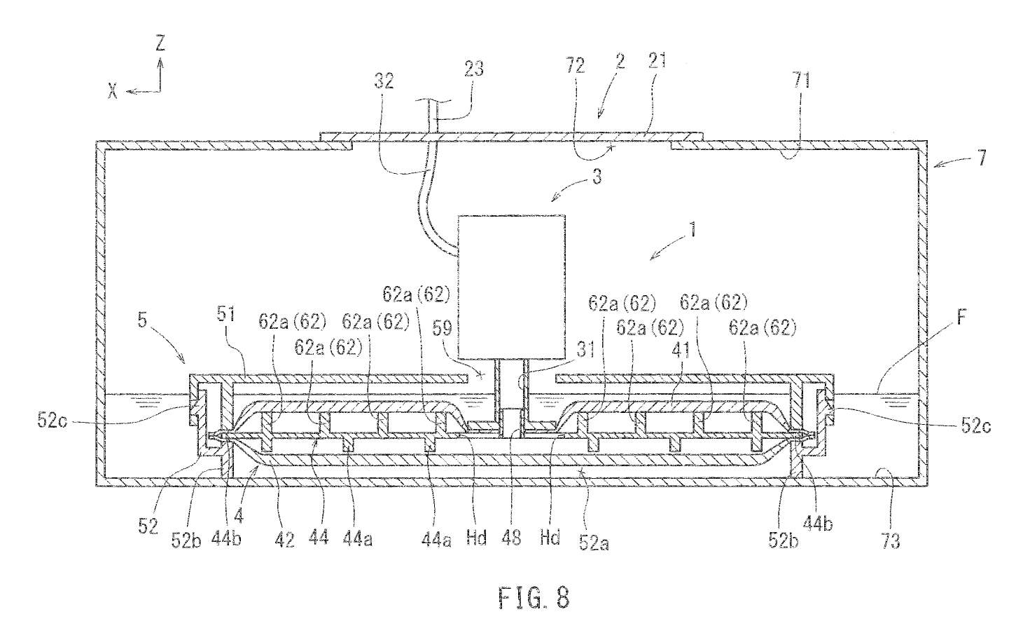

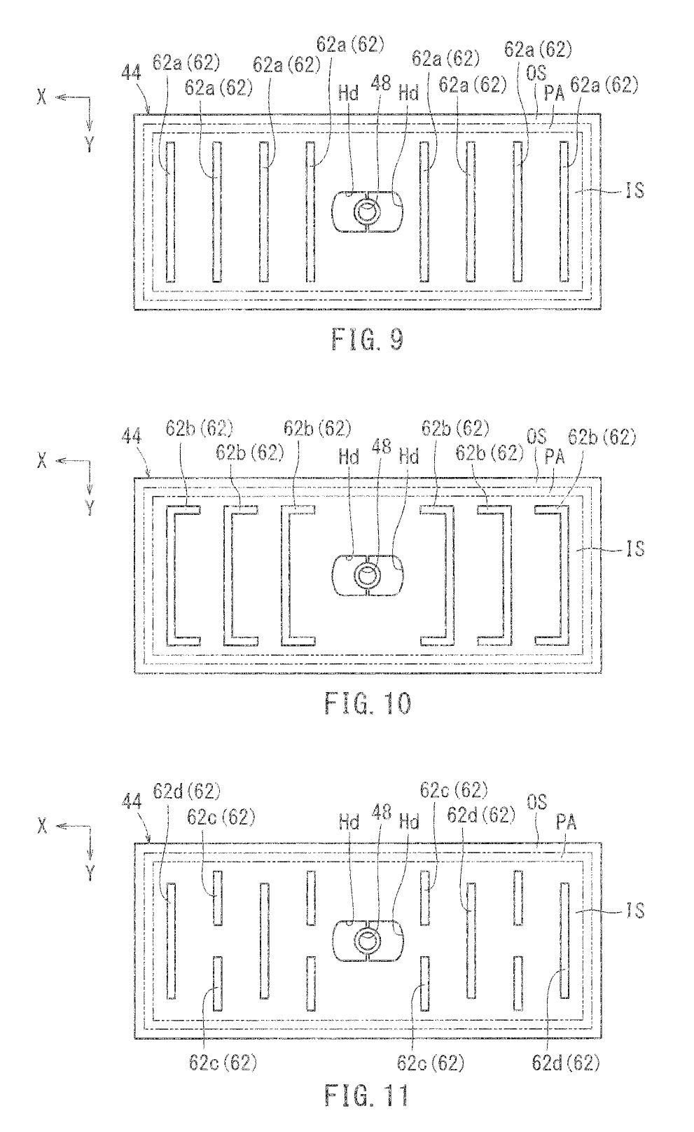

In order to retain the fuel F more easily in the space defined by the inner space-defining-member 44 and the upper outer frame member 51, it is also possible to form projections 62 on the upper surface of the planar inner space-defining-member 44 (see FIG. 8). These projections 62 extend upward between the interposed portion 44b and the through hole Hd to partition a part of the space. More specifically, the projections 62 are formed in a position spaced apart from the interposed portion 44b on an inner plane IS wherein the position is at an inner side of the interposed portion 44b (see FIG. 9 to FIG. 11). The fuel F needs to be shifted to detour around these projections 62 so that the time during which the fuel F stays on the inner space-defining-member 44, i.e. the time the fuel F is retained until the fuel F flows down the through hole Hd may be extended.

As shown in an exemplary embodiment of FIGS. 8 and 9, the projections 62a extend upwardly and are higher than the upper end of the through hole Hd. The projections 62a are configured as substantially rectangular parallelepiped walls extending in a lateral direction. The projections 62a are arranged parallel to each other spaced apart from each other by a predetermined distance in the front-back direction (see FIG. 9). The projections 62a are arranged in front of or back of the through hole Hd so that the fuel F present in a front end side or a rear end side of the inner space-defining-member 44 may be prevented from moving instantly in the hole Hd.

As alternative to the projections 62a shown in FIGS. 8 and 9, it is also possible to form channel steel projections 62b as shown in FIG. 10. An exemplary embodiment shown in FIG. 10, a laterally extending portion is formed with portions extending toward the through hole Hd at right and left ends thereof. The projections 62b of this exemplary are also arranged parallel to each other spaced apart from each other by a predetermined distance in the front-back direction. The projections 62b in the exemplary embodiment of FIG. 10 are formed on the front and rear sides of the through hole Hd wherein the projections 62b have a longer width than a lateral width of the through hole Hd. More specifically, the through hole Hd is positioned between the projections 62b as seen in a plan view wherein the projections 62b are formed in an angled bracket shape.

Although the projections 62 shown in FIGS. 8 and 9 are arranged parallel to each other in a front and back direction, they are not arranged to be parallel in a right and left direction. As an alternative to this embodiment, the projections 62 may be arranged to be dispersed in the front-back direction as well as in the right-left direction. An exemplary embodiment shown in FIG. 11 includes slightly shorter projections 62c and projections 62d that are longer than the projections 62c.

In an exemplary embodiment shown in FIG. 11, the projections 62 that are slightly shorter in length in the right and left direction are arranged parallel to each other in the right-left direction spaced apart at a predetermined distance and are also arranged parallel to each other in the front and back direction spaced apart at a predetermined distance. The projections 62d are longer than the width of the space defined between the projections 62c that arranged in parallel in the right and left direction. The projections 62d are arranged to cover the space. The projections 62d are longer than the projections 62c in the right and left direction. This configuration causes the fuel F present in the front or rear end side to be shifted in a tortuous meandering pathway to reach the through hole Hd.

In the aforementioned exemplary embodiments, a canister filled with an adsorbent material such as an activated carbon may be provided to a cover member.

In the aforementioned exemplary embodiments, the suction port 48 is provided in the approximately center of the inner space-defining-member 44 of the fuel filter 4. Alternatively, the suction port 48 may be provided in a position displaced from the center of the inner space-defining-member 44 in the front-back and/or the right-left direction.

In the aforementioned exemplary embodiments, no components are arranged between the lower filter member 42 and the bottom surface 73 of the fuel tank 7. Alternatively, a mesh member may be arranged to cover a lower plane of the lower filter member 42. Alternatively, a lattice portion may be provided to cover a lower plane of the lower filter member 42. In this way the lower filter member 42 may be prevented from being rubbed with the bottom surface 73 of the fuel tank 7.

In the aforementioned exemplary embodiments, the upper filter member 41 and the lower filter member 42 are nonwoven fabric. Alternatively, the upper filter member 41 and the lower filter member 42 may be woven fabric or porous materials such as a sponge.

In the aforementioned exemplary embodiments, the through holes Ha to Hd of the inner space-defining-member 44 are positioned in locations different from that of the interposed portion 44b. Alternatively or additionally, the through holes may be arranged to overlap or be adjacent to the interposed portion 44b.

In the aforementioned exemplary embodiments, the upper filter member 41 and the lower filter member 42 are not welded to the inner space-defining-member 44. Alternatively, the upper filter member 41 and the lower filter member 41 may be partially welded to the inner space-defining-member 44.

As the aforementioned exemplary embodiments, the entire inner space-defining-member 44 may be encased in a space defined by the upper filter member 41 and the lower filter member 42, or alternatively only a part of the inner space-defining-member 44 may be encased in the space.

In the aforementioned exemplary embodiments, the fuel supply device may be provided on a wheel vehicle. Alternatively, the fuel supply device may be provided on a vehicle that flies in the air, such as an airplane and a helicopter, or that moves over the sea or in the sea, such as a ship and a submarine.

The various exemplary embodiment described above in detail with reference to the attached drawings are intended to be representative of the present invention and thus non limiting embodiments. The detailed description is intended to teach a person of skill in the art to make, use and/or practice various aspects of the present teachings and thus does not limit the scope of the invention in any manner. Furthermore, each of the additional features and teachings disclosed above may be applied and/or used separately or with other features and teachings in any combination thereof, to provide improved fuel vapor processing devices and/or methods of making and using the same.

1. A fuel supply device comprising:
a fuel filter; and
an upper outer frame member and a lower outer frame member, wherein the fuel filter is disposed between the upper outer frame and the lower outer frame member
wherein
the fuel filter includes an upper filter member, a lower filter member and an inner space-defining-member having a portion positioned between the upper filter member and the lower filter member;
wherein a peripheral edge of the upper filter member and a peripheral edge of the lower filter member are joined together;
wherein the inner space-defining-member includes an interposed portion together with the upper filter member and the lower filter member that is fixed between the upper outer frame member and the lower outer frame member.

2. The fuel supply device of claim 1, wherein the interposed portion of the inner space-defining-member is planar.

3. The fuel supply device of claim 1, wherein the inner space-defining-member includes a through hole at a predetermined distance from the interposed portion toward a center of the inner space-defining-member.

4. The fuel supply device of claim 1, wherein an upper surface of the inner space-defining-member includes a projection positioned between the interposed portion and a through hole formed in the inner space-defining-member.

5. A fuel supply device comprising:
a fuel filter; and
an upper outer frame member and a lower outer frame member, wherein the fuel filter is disposed between the upper outer frame member and the lower outer frame member;
wherein the upper outer frame member comprises a laterally planar frame in the left-right and front-back directions with an opening formed at the center in the front-back and left-right direction of the upper outer frame member;
wherein the lower outer frame member comprises a plurality of downwardly extending legs, wherein a space between the downwardly extending legs defines a surface opening;
wherein the fuel filter includes an upper filter member, a lower filter member and an inner space-defining-member having a portion disposed between the upper filter member and lower filter member;
wherein a peripheral edge of the upper filter member and a peripheral edge of the lower filter member are joined together; and
wherein the inner space-defining-member includes an interposed portion together with the upper filter member and the lower filter member that is fixed between the upper outer frame member and the lower outer frame member.

6. The fuel supply device of claim 5, wherein the inner space-defining-member is interposed between the upper filter member and the lower filter member at the left-right and front-back peripheral edges of the inner-space-defining member, wherein the inner-space-defining member is longer than the surface opening in both the left-right and front-back directions.

7. The fuel supply device of claim 5, wherein the interposed portion of the inner space-defining-member is planar with no through-holes.

8. The fuel supply device of claim 5, wherein a through hole is formed in the inner space-defining-member at a predetermined distance from the interposed portion toward a center of the inner space-defining member.

9. The fuel supply device of claim 5, wherein a plurality of through holes are formed at a plurality of positions in the inner space-defining-member at positions spaced apart equally at a predetermined distance from the interposed portion toward a center of the inner space-defining-member.

10. The fuel supply device of claim 9, wherein the through holes form a series of rows and columns spaced apart equally both vertically and horizontally, forming a grid in a plan view.

11. The fuel supply device of claim 5, wherein an upper surface of the inner space-defining-member includes a projection positions between the interposed portion and a through hole formed in the inner space-defining-member.

12. The fuel supply device of claim 5, wherein an upper surface of the inner space-defining member includes a plurality of projections.

13. The fuel supply device of claim 12, wherein the plurality of projections are equally spaced apart.

14. The fuel supply device of claim 5, wherein the upper ad lower filter members are formed of nonwoven fabric material.

15. The fuel supply device of claim 5, wherein a mesh covers the lower filter member and is configured to prevent the lower filter member from engaging a bottom of a tank.

16. The fuel supply device of claim 5, wherein through holes are formed at a plurality of positions in the inner space-defining-member at positions spaced apart at equal intervals, wherein a distance from a rear part of the interposed portion of the inner space-defining-member to the holes in the front-back direction is greater than the distance from a front part of the interposed portion of the inner space-defining member to the holes in the front-back direction.

17. The fuel supply device of claim 12, wherein the plurality of projections are oriented parallel to each other both in the front-back direction as well as in the left-right direction to form a tortuous pathway.

18. The fuel supply device of claim 5, wherein through holes are formed at a plurality of positions in the inner space-defining-member at positions spaced apart a predetermined distance from the interposed portion toward a center of the inner space-defining-member, collectively forming an elliptical shape in the front-back and left-right directional plane.

19. The fuel supply device of claim 5, wherein the lower outer frame member comprises an elastically deformable claw.

20. The fuel supply device of claim 19, wherein the upper outer frame member comprises a hole, wherein the claw of the lower outer frame member fits in to the hole of the upper outer frame member so as to fasten both the frame members to each other.
